(19) United States
(12) Patent Application Publication
(10) Pub. No.: US 2010/0153146 A1
(43) Pub. Date: Jun. 17, 2010

(54) Generating Generalized Risk Cohorts

(75) Inventors: Robert Lee Angell, Salt Lake City, UT (US); Robert R. Friedlander, Southbury, CT (US); James R. Kraemer, Santa Fe, NM (US)

Correspondence Address: Stewart & Liu PLLC, PO Box 797277, Dallas, TX, 75379, US

(73) Assignee: INTERNATIONAL BUSINESS MACHINES CORPORATION, Armonk, NY (US)

(21) Appl. No.: 12/333,256

(22) Filed: Dec. 11, 2008

(51) Int. Cl. G06Q 10/00

(52) U.S. Cl. 705/7

(57) ABSTRACT

A computer implemented method, apparatus, and computer program product for generating general risk scores for general risk cohorts. Digital sensor data associated with a general risk cohort is received from a set of multimodal sensors. The digital sensor data comprises metadata describing attributes associated with at least one member of the general risk cohort. Each member of the general risk cohort comprises data describing objects belonging to a category. A general risk score for the general risk cohort is generated based on selected risk factors and the attributes associated with the at least one member of the general risk cohort. In response to a determination that the general risk score exceeds a risk threshold, a response action is initiated.

### BACKGROUND OF THE INVENTION

1. Field of the Invention

The present invention relates generally to an improved data processing system and in particular to a method and apparatus for generating risk cohorts. More particularly, the present invention is directed to a computer implemented method, apparatus, and computer usable program code for generating general risk cohorts and identifying risk scores for general risk cohorts.

2. Description of the Related Art

Risk may be defined as the chance or probability of injury or loss. Risk assessment is the determination of a quantitative or qualitative value of risk associated with a particular situation or set of circumstance. For example, a merchant's risk of loss of merchandise may increase as the number of customers in the merchant's store increases. Likewise, the merchant's risk of loss of merchandise may decrease as the number of cameras, ink tags, employees, and other security measures are added to monitor those customers. Thus, risk assessment may be useful for health, safety, business, and various other industries.

### BRIEF SUMMARY OF THE INVENTION

According to one embodiment of the present invention, a computer implemented method, apparatus, and computer program product for generating general risk scores for general risk cohorts is provided. Digital sensor data associated with a general risk cohort is received from a set of multimodal sensors. The digital sensor data comprises metadata describing attributes associated with at least one member of the general risk cohort. Each member of the general risk cohort comprises data describing objects belonging to a category. A general risk score for the general risk cohort is generated based on selected risk factors and the attributes associated with the at least one member of the general risk cohort. In response to a determination that the general risk score exceeds a risk threshold, a response action is initiated.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a general risk cohort analysis system in accordance with an illustrative embodiment;

FIG. 4 is a block diagram of a video analysis engine in accordance with an illustrative embodiment;

FIG. 5 is a diagram of selected risk factors used to a generate risk score in accordance with an illustrative embodiment;

FIG. 6 is a flowchart of a process for generating a general risk score for a risk cohort in accordance with an illustrative embodiment; and

FIG. 7 is a flowchart of a process for initiating a response action if a risk score exceeds a risk threshold in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

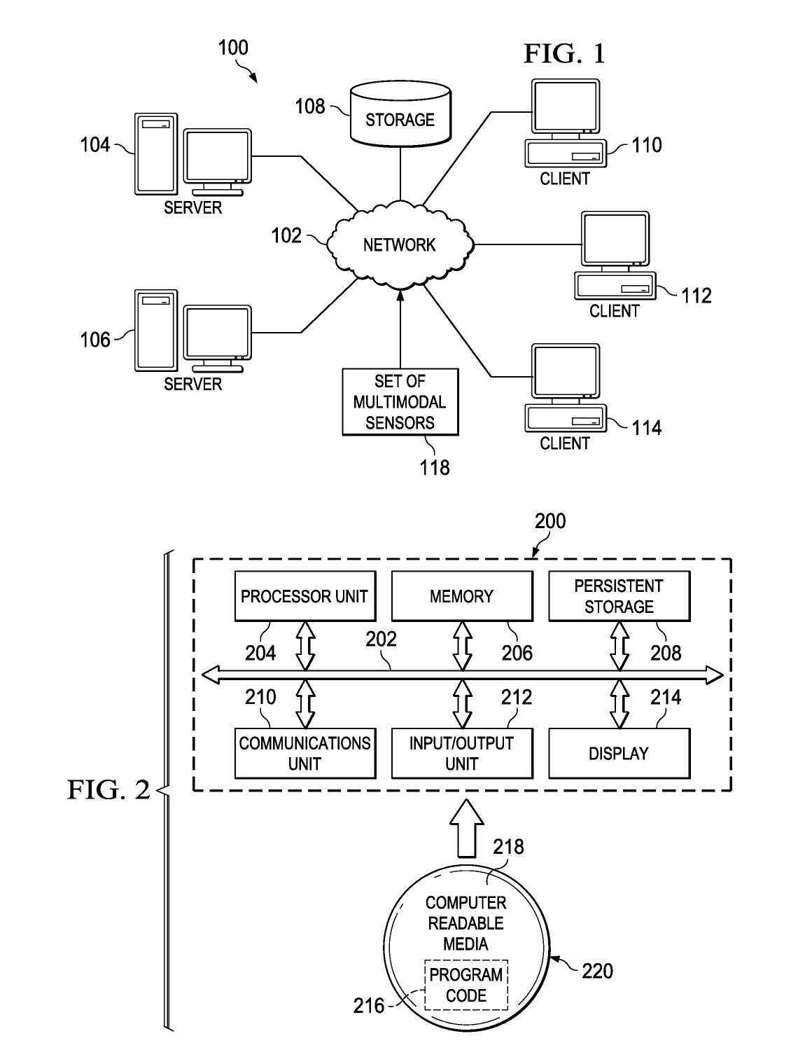

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

Set of multimodal sensors 118 is a set of one or more multimodal sensor devices for gathering information associated with one or more members of a cohort group. A multimodal sensor may any type of device for generating sensor data and transmitting the sensor data to a central data processing system, such as data processing system 100 in FIG. 1. Set of multimodal sensors 118 may include, without limitation, one or more global positioning satellite receivers, infrared sensors, microphones, motion detectors, chemical sensors, biometric sensors, pressure sensors, temperature sensors, metal detectors, radar detectors, photo-sensors, seismographs, anemometers, video cameras, or any other device for gathering information describing at least one member of a cohort. A multimodal sensor includes a transmission device for communicating the information describing members of cohort groups with one or more other multimodal sensors and/or data processing system 100.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as, without limitation, server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. A memory may be, for example, memory 206 or a cache such as found in an interface and memory controller hub that may be present in communications fabric 202.

The illustrative embodiments recognize that the ability to quickly and accurately perform risk assessment to calculate the risks associated with different situations and circumstances may be valuable to business planning, hiring employees, health, safety, future purchases, and various other industries. Thus, according to one embodiment of the present invention, a computer implemented method, apparatus, and computer program product for generating general risk scores for general risk cohorts is provided. A cohort is a group of objects. An object that is a member of a cohort may be a person, an animal, a plant, a location, or a thing. Members of a cohort share a common attribute or experience in common. A cohort may be a member of a larger cohort. Likewise, a cohort may include members that are cohorts, also referred to as sub-cohorts.

In one embodiment, a digital sensor analysis engine receives digital sensor data associated with a general risk cohort from a set of multimodal sensors. As used herein, the term “set” refers to one or more, unless specifically defined otherwise. Thus, the set of multimodal sensors may include a single multimodal sensor, as well as two or more multimodal sensors. The digital sensor data comprises metadata describing attributes associated with at least one member of the general risk cohort. Each member of the general risk cohort comprises data describing objects belonging to a category. A category refers to a class, group, category, or kind. A general cohort is a cohort having members that are general rather than specific. A member of a general cohort is a category or sub-cohort including general or average objects. For example, and without limitation, a general cohort may include a member that is a middle aged, female, with “type 2” diabetes. The cohort member is not any particular person, but instead includes average information, such as, without limitation, any female patients within the age range of 40-45 years old, on a low sugar diet, taking the generic brand, or most commonly prescribed brand of insulin pills, with no other pre-existing medical conditions, and so forth. In another example, a generic cohort may include a member that is a generic pick-up truck, between 5 and 10 years old, with 75,000 to 125,000 miles, and averages 12 to 18 miles per gallon.

In yet another non-limiting example, a general cohort includes a birth cohort of people born in 1980. A birth cohort may include one or more sub-cohorts. For example, the birth cohort of people born in 1980 may include a general sub-cohort of people born in 1980 in Salt Lake City, Utah. A sub-sub-cohort may include people born in 1980 in Salt Lake City, Utah to low income, single parent households. In other words, the members of a general cohort do not include specific members. Instead, general cohorts include members that represent an average, generic, or specified category of objects.

In contrast, a specific cohort is a cohort with specific, identifiable members. For example, a member of a specific cohort may be, without limitation, a patient named Jane Smith, age 42, mother of two children, diagnosed with type 2 diabetes, taking a prescription sulfonylurea drug, and diagnosed with high blood pressure. In another non-limiting example, a specific cohort may include a 2003 green, Toyota Tundra pickup truck with 112,000 miles, new tires, and averaging 14 miles per gallon. Another specific cohort may include a member named Robert Jones born in Salt Lake City, Utah on May 5, 1980 at Salt Lake Regional Hospital to a 22-year-old single mother named Sally Jones.

Thus, a specific cohort includes specific identifiable members rather than generic members of a category of objects. A general risk score for the general risk cohort is generated based on selected risk factors and the attributes associated with the at least one member of the general risk cohort. In response to a determination that the general risk score exceeds a risk threshold, a response action is initiated.

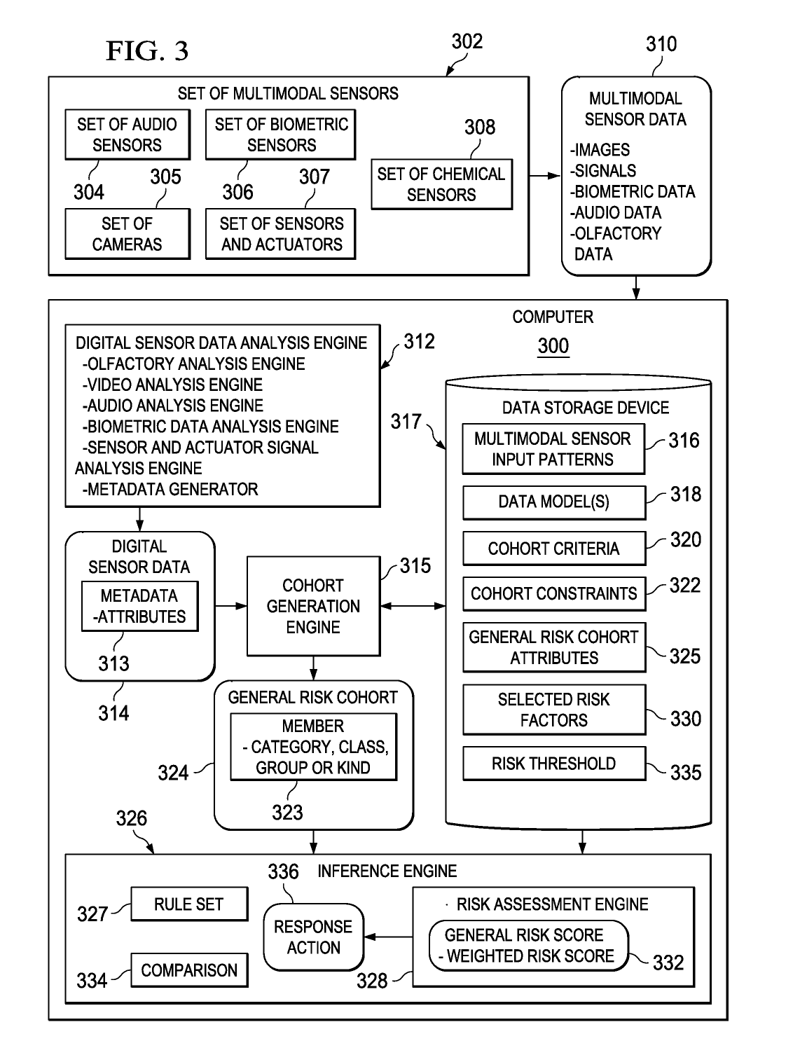

FIG. 3 is a block diagram of a general risk cohort analysis system in accordance with an illustrative embodiment. Computer 300 may be implemented using any type of computing device, such as, but not limited to, a main frame, server, a personal computer, laptop, personal digital assistant (PDA), or any other computing device depicted in FIGS. 1 and 2. Set of multimodal sensors 302 is a set of sensors that gather sensor data associated with a set of objects. An object may be a person, animal, plant, location, or thing. For example, and without limitation, set of multimodal sensors 302 may include a camera that records images of pedestrians walking on a public sidewalk. In this example, the multimodal sensor is a camera and the set of objects may include the pedestrians, dogs, cats, birds, squirrels, or other animals on the sidewalk, the sidewalk itself, the grass on either side of the sidewalk, the trees overhanging the sidewalk, water fountains, balls, or any other things associated with the sidewalk.

In this non-limiting example, set of multimodal sensors 302 includes set of audio sensors 304, set of cameras 305, set of biometric sensors 306, set of sensors and actuators 307, set of chemical sensors 308, and any other types of devices for gathering data associated with a set of objects and transmitting that data to computer 300. Set of multimodal sensors 302 detect, capture, and/or record multimodal sensor data 310.

Set of audio sensors 304 is a set of audio input devices that detect, capture, and/or record vibrations, such as, without limitation, pressure waves, and sound waves. Vibrations may be detected as the vibrations are transmitted through any medium, such as, a solid object, a liquid, a semisolid, or a gas, such as the air or atmosphere. Set of audio sensors 304 may include only a single audio input device, as well as two or more audio input devices. An audio sensor in set of audio sensors 304 may be implemented as any type of device that can detect vibrations transmitted through a medium, such as, without limitation, a microphone, a sonar device, an acoustic identification system, or any other device capable of detecting vibrations transmitted through a medium.

Set of cameras 305 may be implemented as any type of known or available camera(s). A cameral may be, without limitation, a video camera for generating moving video images, a digital camera capable of taking still pictures and/or a continuous video stream, a stereo camera, a web camera, and/or any other imaging device capable of capturing a view of whatever appears within the camera's range for remote monitoring, viewing, or recording of an object or area. Various lenses, filters, and other optical devices such as zoom lenses, wide-angle lenses, mirrors, prisms, and the like, may also be used with set of cameras 305 to assist in capturing the desired view. A camera may be fixed in a particular orientation and configuration, or it may, along with any optical devices, be programmable in orientation, light sensitivity level, focus or other parameters.

Set of cameras 305 may be implemented as a stationary camera and/or non-stationary camera. A stationary camera is in a fixed location. A non-stationary camera may be capable of moving from one location to another location. Stationary and non-stationary cameras may be capable of tilting up, down, left, and right, panning, and/or rotating about an axis of rotation to follow or track an object in motion or keep the object, within a viewing range of the camera lens.

Set of biometric sensors 306 is a set of one or more devices for gathering biometric data associated with a human or an animal. Biometric data is data describing a physiological state, physical attribute, or measurement of a physiological condition. Biometric data may include, without limitation, fingerprints, thumbprints, palm prints, footprints, hear rate, retinal patterns, iris patterns, pupil dilation, blood pressure, respiratory rate, body temperature, blood sugar levels, and any other physiological data. Set of biometric sensors 306 may include, without limitation, fingerprint scanners, palm scanners, thumb print scanners, retinal scanners, iris scanners, wireless blood pressure monitor, heart monitor, thermometer or other body temperature measurement device, blood sugar monitor, microphone capable of detecting heart beats and/or breath sounds, a breathalyzer, or any other type of biometric device.

Set of sensors and actuators 307 is a set of devices for detecting and receiving signals from devices transmitting signals associated with the set of objects. Set of sensors and actuators 307 may include, without limitation, radio frequency identification (RFID) tag readers, global positioning system (GPS) receivers, identification code readers, network devices, and proximity card readers. A network device is a wireless transmission device that may include a wireless personal area network (PAN), a wireless network connection, a radio transmitter, a cellular telephone, Wi-Fi technology, Bluetooth technology, or any other wired or wireless device for transmitting and receiving data. An identification code reader may be, without limitation, a bar code reader, a dot code reader, a universal product code (UPC) reader, an optical character recognition (OCR) text reader, or any other type of identification code reader. A GPS receiver may be located in an object, such as a car, a portable navigation system, a personal digital assistant (PDA), a cellular telephone, or any other type of object.

Set of chemical sensors 308 may be implemented as any type of known or available device that can detect airborne chemicals and/or airborne odor causing elements, molecules, gases, compounds, and/or combinations of molecules, elements, gases, and/or compounds in an air sample, such as, without limitation, an airborne chemical sensor, a gas detector, and/or an electronic nose. In one embodiment, set of chemical sensors 308 is implemented as an array of electronic olfactory sensors and a pattern recognition system that detects and recognizes odors and identifies olfactory patterns associated with different odor causing particles. The array of electronic olfactory sensors may include, without limitation, metal oxide semiconductors (MOS), conducting polymers (CP), quartz crystal microbalance, surface acoustic wave (SAW), and field effect transistors (MOSFET). The particles detected by set of chemical sensors may include, without limitation, atoms, molecules, elements, gases, compounds, or any type of airborne odor causing matter. Set of chemical sensors 308 detects the particles in the air sample and generates olfactory pattern data in multimodal sensor data 310.

Digital sensor data analysis engine 312 is software architecture for processing multimodal sensor data 310 to identify attributes of the set of objects, convert sensor data in an analog format into a digital format, and generate metadata describing the attributes to form digital sensor data 314. Multimodal sensor data 310 may include sensor input in the form of audio data, images from a camera, biometric data, signals from sensors and actuators, and/or olfactory patterns from an artificial nose or other chemical sensor.

Digital sensor data analysis engine 312 may include a variety of software tools for processing and analyzing these different types of multimodal sensor data. In FIG. 3, digital sensor data analysis engine 312 includes, without limitation, olfactory analysis engine for analyzing olfactory sensory data received from set of chemical sensors 308, a video analysis engine for analyzing images received from set of cameras 305, an audio analysis engine for analyzing audio data received from set of audio sensors 304, biometric data analysis engine for analyzing biometric sensor data from set of biometric sensors 306, sensor and actuator signal analysis engine for analyzing sensor input data from set of sensors and actuators 307, and a metadata generator for generating metadata describing the attributes of the set of objects.

Digital sensor data 314 comprises metadata 313 describing attributes of the set of objects. An attribute is a characteristic, feature, or property of an object. In a non-limiting example, an attribute may include a person's name, address, eye color, age, voice pattern, color of their jacket, size of their shoes, speed of their walk, length of stride, marital status, identification of children, make of car owned, and so forth. Attributes of a thing may include the name of the thing, the value of the thing, whether the thing is moving or stationary, the size, height, volume, weight, color, or location of the thing, and any other property or characteristic of the thing.

Cohort generation engine 315 receives digital sensor data 314 from digital sensor data analysis engine 312. Cohort generation engine 315 may request digital sensor data 314 from digital sensor data analysis engine 312 or retrieve digital sensor data 314 from data storage device 317. In another embodiment, digital sensor data analysis engine 312 automatically sends digital sensor data 314 to cohort generation engine 315 in real time as digital sensor data 314 is generated. In yet another embodiment, digital sensor data analysis engine 312 sends digital sensor data 314 to cohort generation engine 315 upon the occurrence of a predetermined event. A predetermined event may be, but is not limited to, a given time, completion of processing multimodal sensor data 310, occurrence of a timeout event, a user request for generation of set of cohorts based on digital sensor data 314, or any other predetermined event. The illustrative embodiments may utilize digital sensor data 314 in real time as digital sensor data 314 is generated or utilize digital sensor data 314 that is pre-generated or stored in a data storage device until the digital sensor data is retrieved at some later time.

Cohort generation engine 315 utilizes attributes identified in digital sensor data 314 to generate general risk cohort 324. Cohort generation engine 315 may utilize at least one of multimodal sensor input patterns 316, data model(s) 318, cohort criteria 320, and cohort constraints 322 to process the attributes and select members of one or more cohorts, such as general risk cohort 324 or digital sensor data analysis engine 312. As used herein, the term “at least one of”, when used with a list of items, means that different combinations of one or more of the items may be used and only one of each item in the list may be needed. For example, “at least one of item A, item B, and item C” may include, for example, without limitation, item A alone, item B alone, item C alone, a combination of item A and item B, a combination of item B and item C, a combination of item A and item C, or a combination that includes item A, item B, and item C.

Multimodal sensor input patterns 316 are known multimodal sensor patterns resulting due to different combinations of multimodal sensor input in different environments. Each different type of sensor data and/or combination of sensor data in a particular environment creates a different sensor data pattern. When a match is found between known sensor patterns and some of the received sensor data, the matching pattern may be used to identify attributes of a particular set of objects.

For example, and without limitation, a pattern of sensor data may indicate that a person is able to afford the latest products or likely to spend a lot of money at a retail store if sensor data from expensive or designer products owned by a person are received. For example, signals may be received from an iphone™ cellular telephone, an RFID tag identifying the person's clothing and shoes as expensive designer clothing, and GPS receiver and/or a navigation system in a car owned by the person. In addition, a signal may also be received from a microchip implant in a dog that is owned by the person. The sensor data that are received from the person, the car, and the dog that is owned by the person creates a pattern that suggests the person is a consumer with a high income and/or a tendency to purchase expensive or popular and technology.

Cohort generation engine 315 may also utilize manual user input to generate general risk cohort 324. In other words, a user may manually select parameters used by cohort generation engine 315 to select members of general risk cohort 324 or a user may manually select the members of general risk cohort 324. General risk cohort 324 is a cohort that includes generalized or generic members rather than specific identifiable objects. In other words, member 323 of general risk cohort 324 comprises a representative of a category, group, class, or kind, rather than a specific identifiable person or thing.

In a non-limiting example, general risk cohort 324 is a risk cohort for teenage drivers. The members of general risk cohort 324 may include a cohort member that is a male teenage driver between the ages of 15 and 19 that has passed a drivers education course and obtained a driver's license. Other members of general risk cohort 324 may include a set of roadways in a city near a public high school that is frequently driven on by teenagers. Another general risk cohort member may be make and/or model of motorcycle that is frequently purchased and driven by teenagers. General risk cohort 324 does not include as a member a specific driver, such as 18 year old Peter Jones that has been driving for 2 years and has received 3 moving vehicle citations. Instead, general risk cohort 324 includes an average, male teenager driver. The average male teenage driver in this example has received 0 to 1 moving vehicle citations.

In one embodiment, the attributes for objects in general risk cohort 324 are stored in data storage device 317 as general risk cohort attributes 325. Data storage device 317 is any type of device for storing data, such as, without limitation, storage 108 in FIG. 1. Inference engine 326 analyzes general risk cohort attributes 325 for general risk cohort with selected risk factors to generate general risk score 332. Inference engine 326 retrieves general risk cohort attributes 325 from risk assessment engine 328. In another embodiment, inference engine 326 identifies general risk cohort attributes 325 by analyzing digital sensor data 314. In yet another embodiment, cohort generation engine 315 transmits general risk cohort 324 with general risk cohort attributes 325 to inference engine 326.

Inference engine 326 is a computer program that derives inferences from a knowledge base. In this example, inference engine 326 derives inferences from risk assessment engine 328 from cohort data generated by cohort generation engine 315, digital sensor data 314, general risk cohort attributes 325, and/or any other data available in the knowledge base. The data in the knowledge base may include data located in data storage device 317 as well as data located on one or more remote data storage devices that may be accessed using a network connection.

Inferences are conclusions regarding the chance or probability of the occurrence of possible future events or future changes in the attributes of cohorts that are drawn or inferred based on current facts, rule set 327, information in the knowledge base, digital sensor data 314, and general risk cohort attributes 325.

Rule set 327 specifies information to be searched, using queries, data mining, or other search techniques. For example, if general risk cohort 324 requires a probability that following surgery a patient my need more than one round of antibiotics, rule set 327 may specify searching for a history of infections for the patient's demographic group and the history of infections in patients having the same surgery. Rule set 327 may also specify certain interrelationships between data sets that will be searched. Inference engine 326 uses data in a centralized database to derive inference(s) and calculate probabilities of events based on comparison of available data according to rule set 327.

Risk assessment engine 328 calculates general risk score 332 based on selected risk factors 330. A risk factor is an element or probable event that is to be considered in calculating general risk score. There may be dozens or hundreds of possible risk factors for a given general risk cohort. Therefore, a user or risk assessment engine 328 selects one or more risk factors that are used in calculating general risk score. A risk factor may be a default risk factor that is selected a priori. A risk factor may also be selected dynamically by a user or by risk assessment engine 328 as multimodal sensor data 310 is being received and/or processed to generate general risk cohort 324.

Comparison 334 is a software component that compares general risk score 332 to risk threshold 335. Risk threshold 335 may be a risk threshold that is determined a priori, such as a default threshold. Risk threshold 335 may also be determined on an iterative convergence factor, such as, without limitation, 0.02.

If the general risk score 332 does not exceed an upper risk threshold or fall below a lower risk threshold, then inference engine 326 continues to monitor for new digital sensor data 314 from set of multimodal sensors 302. Inference engine 326 continues to update general risk score 332 in response to changes in events and attributes indicated by changes in incoming digital sensor data 314 and changes in manual input received from a user. If general risk score exceeds an upper risk threshold 335 or falls below a lower risk threshold, then risk assessment engine 328 initiates a response action 336.

Response action 336 may be a recommendation that a user take a specified action to either reduce the risk score or increase the risk score. For example, and without limitation, a general risk cohort may monitor the risk of crime in certain business districts. If general risk score 332 exceeds risk threshold 335 it may indicate that the crime rate and incidents of crimes have increased in a given area. In such a case, response action 336 may recommend increasing the number of police officers patrolling in the area, sending warnings to residents and business owners to be cautious, recommend a curfew for teenagers, recommend increasing lighting in the area, or other recommendations intended to decrease the risk of crime. Response action 336 may also be an action that is initiated by risk assessment engine 328. For example, and without limitation, response action 336 may activate additional street lights in the area, display crime watch messages on monitors and electronic billboards in the area, send an electronic message to business owners regarding the increased risk, or other actions intended to lower the risk score.

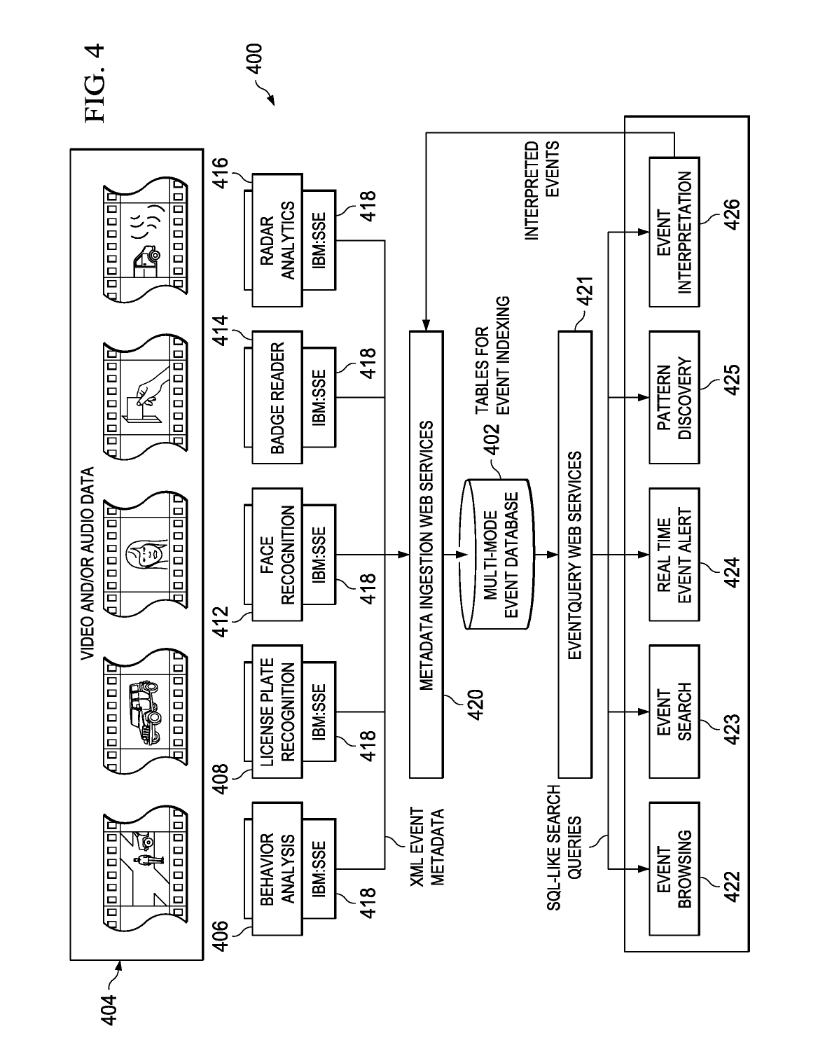

Referring now to FIG. 4, a block diagram of a video analysis engine is depicted in accordance with an illustrative embodiment. Video analysis system 400 is software architecture for generating metadata describing attributes of objects based on an analysis of camera images captured by a set of video cameras. Video analysis system 400 may be part of a software component for analyzing multimodal sensor data to generate digital sensor data, such as digital sensor data analysis engine 312 in FIG. 3. Video analysis system 400 may be implemented using any known or available software for image analytics, facial recognition, license plate recognition, and sound analysis. In this example, video analysis system 400 is implemented as IBM® smart surveillance system (S3) software.

Video analysis system 400 utilizes computer vision and pattern recognition technologies, as well as video analytics, such as set of cameras 305 in FIG. 3, to analyze video images captured by one or more situated cameras and/or microphones. The analysis of the video data generates events of interest in the environment.

Video analysis system 400 includes video analytics software for analyzing video images captured by a camera and/or audio captured by an audio device associated with the camera. The video analytics engine includes software for analyzing video and/or audio data 404. In this example, the video analytics engine in video analysis system 400 processes video and/or audio data 404 associated with one or more objects into data and metadata. In this non-limiting example, video and/or audio data 404 is received from a variety of audio/video capture devices, such as set of multimodal sensors 302 in FIG. 3. Video and/or audio data 404 is processed in analytics engine(s) 418.

Video and/or audio data 404 may be a sound file, a media file, a moving video file, a still picture, a set of still pictures, or any other form of image data and/or audio data. Video and/or audio data 404 may include, for example and without limitation, images of a person's face, an image of a part or portion of a customer's car, an image of a license plate on a car, and/or one or more images showing a person's behavior. In a non-limiting example, an image showing a customer's behavior or appearance may show a customer wearing a long coat on a hot day, a customer walking with two small children, a customer moving in a hurried or leisurely manner, or any other type behavior of one or more objects.

In this non-limiting example, the video analytics technologies comprise, without limitation, behavior analysis 406, license plate recognition 408, face recognition 412, badge reader 414, and radar analytics 416 technology. Behavior analysis 406 technology tracks moving objects and classifies the objects into a number of predefined categories by analyzing metadata describing images captured by the cameras. As used herein, an object may be a human, an object, a container, a cart, a bicycle, a motorcycle, a car, a location, or an animal, such as, without limitation, a dog. License plate recognition 408 may be utilized to analyze images captured by cameras deployed at the entrance to a facility, in a parking lot, on the side of a roadway or freeway, or at an intersection. License plate recognition 408 catalogs a license plate of each vehicle moving within a range of two or more video cameras associated with video analysis system 400. For example, license plate recognition technology 408 is utilized to identify a license plate number on license plate.

Face recognition 412 is software for identifying a human based on an analysis of one or more images of the human's face. Face detection/recognition technology 412 may be utilized to analyze images of objects captured by cameras deployed at entryways, or any other location, to capture and recognize faces. Badge reader 414 technology may be employed to read badges. The information associated with an object obtained from the badges is used in addition to video data associated with the object to identify an object and/or a direction, velocity, and/or acceleration of the object. Events from access control technologies can also be integrated into video analysis system 400.

The data gathered from behavior analysis 404, license plate recognition 408, face recognition 412, badge reader 414, radar analytics 416, and any other video/audio data received from a camera or other video/audio capture device is received by video analysis system 400 for processing into metadata 425 describing events and/or attributes of one or more objects in a given area. The events from all these technologies are cross indexed into a common repository or a multi-mode event database 402 allowing for correlation across multiple audio/video capture devices and event types. In such a repository, a simple time range query across the modalities will extract license plate information, vehicle appearance information, badge information, object location information, object position information, vehicle make, model, year and/or color, and face appearance information. This permits video analysis software to easily correlate these attributes.

Video analysis system 400 may include metadata ingestion web services 420 and event query web services 421, which provides infrastructure for indexing, retrieving, and managing event metadata. Each analytics engine 418 can generate real-time alerts and generic event metadata. The metadata generated by analytics engine 418 may be represented using, for example and without limitation, extensible markup language (XML). Retrieval services may include, for example, event browsing 422, event search 423, real time event alert 424, pattern discovery 425, and/or event interpretation 426. Each event has a reference to the original media resource, such as, without limitation, a link to the video file. This allows the user to view the video associated with a retrieved event.

Metadata ingestion web services 420 and event query web services 421 may include, without limitation, a J2EE™ frame work built around IBM's DB2™ and IBM WebSphere™ application server platforms. Meta data ingestion web services 420 support the indexing and retrieval of spatio-temporal event metadata. Meta data ingestion web services 420 also provides analysis engines with the following support functionalities via standard web services interfaces, such as, without limitation, extensible markup language (XML) documents.

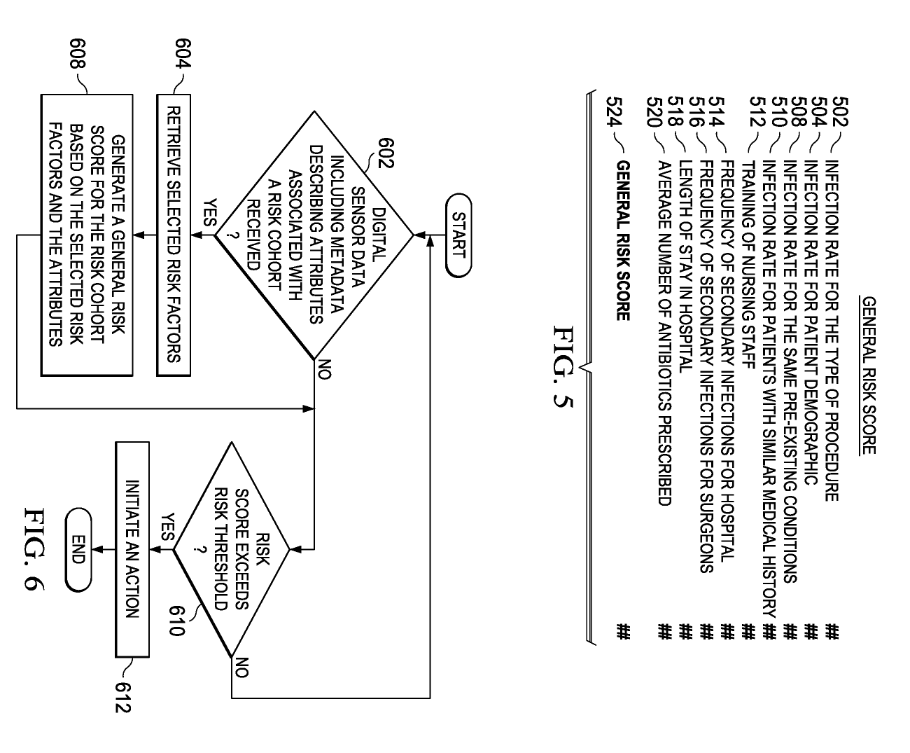

FIG. 5 is a block diagram of selected risk factors used to generate a general risk score in accordance with an illustrative embodiment. Risk factors are factors that are used to generate a general risk score for a risk cohort. Each risk factor has a score, probability, or percentage chance associated with the risk factor. For example, if a risk cohort is a coin flipping risk cohort where an average elementary school aged child flips a coin while standing on a park sidewalk, there are various risk factors that could be selected for utilization in calculating a risk score. For example, and without limitation, selected risk factors could include a coin landing heads side up and the coin landing on edge. When a coin is flipped, a risk factor for the coin landing on heads is approximately 1 in 2 or 50%. A risk factor for the coin landing on its edge will be significantly lower, such as, without limitation, 1 in 6000. In another non-limiting example, the selected risk factors may include the chance the coin will roll away and be lost or the chance that the coin will be taken by another child. Each selected risk factor may have a weighting associated with it. In this case, the weighting for the child losing the coin may be higher than the weighting for the coin landing on edge, because the user is more concerned with the monetary loss of the coin and less concerned with performing multiple coin tosses in the event that the coin does not land either heads up or tails up. The risk factors are used to determine the potential risk of a particular risk or loss associated with the risk cohort. The risk score changes as different risk factors are selected or de-selected and as the weighting for each risk factor changes.

In this non-limiting example in FIG. 5, the risk factors are factors associated with a risk cohort comprising a middle-aged woman having her thyroid removed by an average qualified surgeon at a typical hospital with normally equipped surgical facilities. In such a case, the risk factors may include, without limitation, infection rate for this type of procedure 502, infection rate for patient demographic 504 of middle aged women, infection rate with the same pre-existing conditions 508, infection rate for patients with similar medical history 510, training of typical nursing staff 512, frequency of secondary infections for hospitals 514, frequency of secondary infections for surgeons 516, length of stay in hospital 518, and average number of antibiotics prescribed 520 for typical thyroid removal procedures. Risk factors could include all these risk factors or only some of these risk factors. In addition, the risk factors for this surgery related risk cohort could also include additional factors not shown in FIG. 5, such as rate of occurrence of sepsis, or any other factors associated with the risk cohort of middle-aged females having thyroid removal surgery. The risk factors are used in generating a general risk cohort 524.

In this non-limiting example in FIG. 5, the risk cohort is a risk cohort for a patient having a surgical procedure. However, the risk cohorts of the embodiments are not limited to risk cohorts for patients having surgical procedures. A general risk cohort may be any type of general cohort, such as, without limitation, a risk cohort of risks to a storeowner selling a product, risks to a passenger traveling in a vehicle, risks for a family deep frying a turkey, risks to a jogger jogging on a public road, or any other type of risk. For example, in the case of a risk cohort for a jogger jogging on the weekends, the risk factors may include, without limitation, average amount of traffic in an a particular area on typical weekends, the number of accidents and injuries to joggers jogging on weekends, the average number of joggers that go jogging on weekends, and so forth.

FIG. 6 is a flowchart of a process for generating a general risk score for a risk cohort in accordance with an illustrative embodiment. The process in FIG. 6 may be implemented by software for generating a general risk score for a general risk cohort, such as inference engine 326 in FIG. 3. The process begins by determining whether digital sensor data including metadata describing attributes associated with a risk cohort is received (step 602). The inference engine retrieves selected risk factors (step 604). The selected risk factors may be risk factors that are default risk factors selected a priori or risk factors that are dynamically selected by a user.

The inference engine generates a general risk score for the risk cohort based on the selected risk factors and the attributes (step 608). The inference engine makes a determination as to whether the risk score exceeds a risk threshold (step 610). If the general risk score does not exceed the threshold, the process returns to step 602. Returning to step 610, if the risk score exceeds the risk threshold, the risk assessment engine initiates a response action (step 612) with the process terminating thereafter.

In FIG. 6, an action is taken if the risk score exceeds the risk threshold. However, in another embodiment, an action may be taken if the general risk score is lower than the risk threshold.

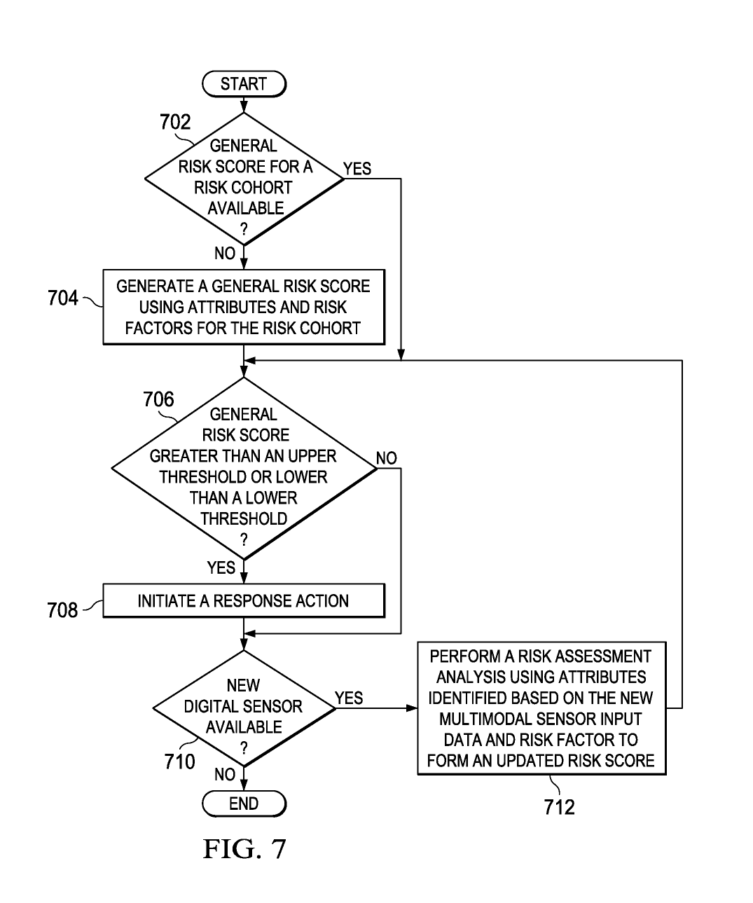

Turning now to FIG. 7, a flowchart of a process for initiating a response action if a risk score exceeds a risk threshold is shown in accordance with an illustrative embodiment. The process in FIG. 7 may be implemented by software for generating a risk score and initiating an action if the risk score falls below a threshold, such as inference engine 326 in FIG. 3. The process makes a determination as to whether a general risk score for a risk cohort is available (step 702). If a risk score is not available, the process generates a general risk score using attributes and risk factors for the risk cohort (step 704). If the general risk score is available at step 702 or after a general risk score is generated at step 704, the process determines whether the general risk score is greater than an upper threshold or lower than a lower threshold (step 706). In response to determining that the risk score is either greater than the upper threshold or lower than the lower threshold, the process initiates a response action (step 708).

Returning to step 706, if the general risk score is not greater than an upper risk threshold or lower than a lower threshold at step 706 or after initiating a response action at step 708, the process makes a determination as to whether new digital sensor data is available (step 710). If new digital sensor data is available, the risk assessment engine performs a risk assessment analysis using attributes identified based on the new multimodal sensor input data and risk factors to form an updated risk score (step 712). The process then returns to step 706. When new digital sensor data is not available at step 710, the process terminates thereafter.

In this example, the risk threshold includes both an upper threshold and a lower threshold. However, the embodiments are not limited to a single upper threshold and a single lower threshold. The embodiments may use only a lower threshold for comparison with the general risk score, utilize only an upper threshold for comparison with the risk score, or utilize a series of thresholds. For example, the initial general risk score may be compared to a first risk threshold. In response to receiving new digital sensor data, a second risk score may be generated. The second risk score may then be compared to a second risk score. In response to new digital sensor data, a third general risk score may be generated that is compared to a third risk threshold, and so forth iteratively for as long as new sensor data is available. As shown here, the first risk threshold, the second risk threshold, and/or the third risk threshold may be a single threshold or an upper threshold and a lower threshold. In other words, the second general risk score may be compared to a second risk threshold that includes both an upper threshold and a lower threshold.

Thus, according to one embodiment of the present invention, a computer implemented method, apparatus, and computer program product for generating general risk scores for general risk cohorts is provided. Digital sensor data associated with a general risk cohort is received from a set of multimodal sensors. The digital sensor data comprises metadata describing attributes associated with at least one member of the general risk cohort. Each member of the general risk cohort comprises data describing objects belonging to a category. A general risk score for the general risk cohort is generated based on selected risk factors and the attributes associated with the at least one member of the general risk cohort. In response to a determination that the general risk score exceeds a risk threshold, a response action is initiated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of generating general risk scores for general risk cohorts, the computer implemented method comprising:
receiving digital sensor data associated with a general risk cohort from a set of multimodal sensors, wherein the digital sensor data comprises metadata describing attributes associated with at least one member of the general risk cohort, wherein each member of the general risk cohort comprises data describing objects belonging to a category;
generating a general risk score for the general risk cohort based on selected risk factors and the attributes associated with the at least one member of the general risk cohort; and
responsive to a determination that the general risk score exceeds a risk threshold, initiating a response action.

2. The computer implemented method of claim 1 further comprising:
responsive to a determination that the general risk score fails to exceed a risk threshold, monitoring digital sensor data associated with the general risk cohort that is received from the set of multimodal sensors.

3. The computer implemented method of claim 2 wherein the response action is a first response action and wherein monitoring the digital sensor data further comprises:
responsive to a determination that new digital sensor data associated with the general risk cohort is available, receiving the digital sensor data, wherein the new digital sensor data comprises updated metadata describing updated attributes associated with the at least one member of the general risk cohort;
generating an updated general risk score for the general risk cohort based on the selected risk factors and the updated attributes;
comparing the updated general risk score with the risk threshold;
responsive to a determination that the updated general risk score fails to exceed the risk threshold, ceasing the first response action; and
responsive to a determination that the updated general risk score exceeds the risk threshold, initiating a second response action, wherein the process iteratively generates updated general risk scores using updated sensor data to monitor risk scores and initiate response actions when any risk score exceeds the risk threshold.

4. The computer implemented method of claim 1 wherein the response action is a first response action and wherein monitoring the digital sensor data further comprises:
responsive to a determination that updated risk factors are selected, generating an updated general risk score for the general risk cohort based on the updated risk factors and the attributes associated with the at least one member of the general risk cohort;
responsive to a determination that the updated general risk score fails to exceed the risk threshold, ceasing the first response action; and
responsive to a determination that the updated general risk score exceeds the risk threshold, initiating a second response action, wherein the process iteratively generates updated general risk scores using updated sensor data to monitor risk scores and initiate response actions when any risk score exceeds the risk threshold

5. The computer implemented method of claim 1 wherein the risk threshold comprises an upper risk threshold and a lower risk threshold, and wherein general risk score exceeds the risk threshold if the risk score exceeds an upper risk threshold, and wherein the general risk score exceeds the risk threshold if the risk score is less than a lower risk threshold.

6. The computer implemented method of claim 1 wherein receiving digital sensor data associated with a general risk cohort from a set of multimodal sensors further comprises:
receiving digital cohort data for a set of multimodal cohorts, wherein the digital cohort data comprises metadata describing attributes of members of the set of multimodal cohorts; and
generating the general risk score for the general risk cohort based on the selected risk factors, the attributes associated with the set of multimodal cohorts, and the attributes associated with the at least one member of the general risk cohort.

7. The computer implemented method of claim 6 wherein the set of multimodal cohorts comprises at least one of a video cohort, an audio cohort, an olfactory cohort, a biometric cohort, a furtive glance cohort, and a sensor and actuator cohort.

8. The computer implemented method of claim 1 further comprising:
analyzing the digital sensor data using manual input and at least one of cohort criteria, cohort constraints, a set of data models, and risk patterns to generate the general risk cohort.

9. The computer implemented method of claim 1 further comprising:
analyzing the selected risk factors using at least one of manual input from a user and a lookup table of weight indicators to generate weighted risk factors; and
identifying a weighted risk score associated with the general risk cohort based on the weighted risk factors, wherein the response action is initiated if the weighted risk score exceeds the risk threshold.

10. The computer implemented method of claim 1 wherein the set of multimodal sensors comprises at least one of a set of chemical sensors, a set of audio sensors, a set of cameras, a set of biometric sensors, and a set of sensors and actuators, and further comprising:
responsive to receiving sensor data from the set of multimodal sensors, processing the sensor data to the form digital sensor data, wherein a sensor data analysis engine converts any input received in an analog format into a digital format to form the digital sensor data.

11. A computer program product for generating risk scores for general risk cohorts, the computer program product comprising:
a computer usable medium having computer usable program code embodied therewith, the computer usable program code comprising:
computer usable program code configured to receive digital sensor data associated with a general risk cohort from a set of multimodal sensors, wherein the digital sensor data comprises metadata describing attributes associated with at least one member of the general risk cohort, wherein each member of the general risk cohort comprises data describing objects belonging to a category;
computer usable program code configured to generate a general risk score for the general risk cohort based on selected risk factors and the attributes associated with the at least one member of the general risk cohort; and
computer usable program code configured to initiate a response action, in response to a determination that the general risk score exceeds a risk threshold.

12. The computer program product of claim 11 further comprising:
computer usable program code configured to monitor digital sensor data associated with the general risk cohort that is received from the set of multimodal sensors in response to a determination that the general risk score fails to exceed a risk threshold.

13. The computer program product of claim 11 wherein the response action is a first response action and further comprising:
computer usable program code configured to receive the digital sensor data in response to a determination that new digital sensor data associated with the general risk cohort is available, wherein the new digital sensor data comprises updated metadata describing updated attributes associated with the at least one member of the general risk cohort;
computer usable program code configured to generate an updated general risk score for the general risk cohort based on the selected risk factors and the updated attributes;
computer usable program code configured to compare the updated general risk score with the risk threshold;
computer usable program code configured to cease the first response action in response to a determination that the updated general risk score fails to exceed the risk threshold; and
computer usable program code configured to initiate a second response action in response to a determination that the updated general risk score exceeds the risk threshold, wherein the process iteratively generates updated general risk scores using updated sensor data to monitor risk scores and initiate response actions when any risk score exceeds the risk threshold.

14. The computer program product of claim 11 wherein the response action is a first response action further comprising:
computer usable program code configured to generate an updated general risk score for the general risk cohort based on the updated risk factors and the attributes associated with the at least one member of the general risk cohort in response to a determination that updated risk factors are selected;
computer usable program code configured to cease the first response action in response to a determination that the updated general risk score fails to exceed the risk threshold; and
computer usable program code configured to initiate a second response action in response to a determination that the updated general risk score exceeds the risk threshold, wherein the process iteratively generates updated general risk scores using updated sensor data to monitor risk scores and initiate response actions when any risk score exceeds the risk threshold.

15. The computer program product of claim 11 wherein the risk threshold comprises an upper risk threshold and a lower risk threshold, and wherein general risk score exceeds the risk threshold if the risk score exceeds an upper risk threshold; and wherein the general risk score exceeds the risk threshold if the risk score is less than a lower risk threshold.

16. An apparatus comprising:
a bus system;
a communications system coupled to the bus system;
a memory connected to the bus system, wherein the memory includes computer usable program code; and
a processing unit coupled to the bus system, wherein the processing unit executes the computer usable program code to receive digital sensor data associated with a general risk cohort from a set of multimodal sensors, wherein the digital sensor data comprises metadata describing attributes associated with at least one member of the general risk cohort, wherein each member of the general risk cohort comprises data describing objects belonging to a category, generates a general risk score for the general risk cohort based on selected risk factors and the attributes associated with the at least one member of the general risk cohort, and initiates a response action, in response to a determination that the general risk score exceeds a risk threshold.

17. The apparatus of claim 16 wherein the processing unit executes the computer usable program code to monitor digital sensor data associated with the general risk cohort that is received from the set of multimodal sensors in response to a determination that the general risk score fails to exceed a risk threshold.

18. The apparatus of claim 16 wherein the processing unit executes the computer usable program code to receive the digital sensor data in response to a determination that new digital sensor data associated with the general risk cohort is available, wherein the new digital sensor data comprises updated metadata describing updated attributes associated with the at least one member of the general risk cohort, generate an updated general risk score for the general risk cohort based on the selected risk factors and the updated attributes, compare the updated general risk score with the risk threshold, and cease the first response action in response to a determination that the updated general risk score fails to exceed the risk threshold, and initiate a second response action in response to a determination that the updated general risk score exceeds the risk threshold, wherein the process iteratively generates updated general risk scores using updated sensor data to monitor risk scores and initiate response actions when any risk score exceeds the risk threshold.

19. The apparatus of claim 16 wherein the risk threshold comprises an upper risk threshold and a lower risk threshold, wherein general risk score exceeds the risk threshold if the risk score exceeds an upper risk threshold, and wherein the general risk score exceeds the risk threshold if the risk score is less than a lower risk threshold.

20. A general risk cohort risk analysis system comprising:
a set of multimodal sensors, wherein the set of multimodal sensors generates sensor data associated with a general risk cohort;
a digital sensor data analysis engine, wherein the digital signal analysis engine processes the sensor data to form digital sensor data associated with a general risk cohort, wherein the digital sensor data comprises metadata describing attributes associated with at least one member of the general risk cohort, wherein each member of the general risk cohort comprises data describing objects belonging to a category; and
an inference engine, wherein the inference engine comprises a risk assessment engine, wherein the risk assessment engine generate a general risk score for the general risk cohort based on selected risk factors and the attributes associated with the at least one member of the general risk cohort, and initiates a response action, in response to a determination that the general risk score exceeds a risk threshold.
